(19) United States
(12) Patent Application Publication
(10) Pub. No.: US 2005/0066293 A1
(43) Pub. Date: Mar. 24, 2005

(54) Tree and table GUI

(76) Inventor: Simon Derek Hunt, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/667,473

(22) Filed: Sep. 23, 2003

(51) Int. Cl. G06F 3/00

(52) U.S. Cl. 715/854; 715/853; 715/855; 715/734

(57) ABSTRACT

A method generates a graphical portion of a graphical user interface (GUI), the graphical portion concerning various components of a storage domain. Such a method may include: illustrating a tree hierarchy; including, in the tree hierarchy, a node belonging to a first node-category, the first-category node representing the total instances of a particular type among the storage-domain components, and including, in the tree hierarchy, one or more subset nodes belonging to a second node-category reporting to the first-category node, each second-category subset node representing a subset of the total instances of the particular type of storage-domain component. Related apparatus and machine-readable media having instructions can each include features similar to elements of the method.

### BACKGROUND OF THE INVENTION

Graphical user interfaces (GUIs) that use a treetable are known, as are many variations, e.g., the two-pane tree & table combination GUI found in the Windows® Explorer® model of file browser made available by the Microsoft® Corporation. The Windows® Explorer®-type GUI shows a tree whose nodes are categorized either as folders or files.

When a node in the tree hierarchy of the Windows® Explorer®-type GUI is selected by a user, the GUI adaptively illustrates a table showing information child nodes that report to the selected tree node. Sizes for child nodes are shown in the table only if the child node corresponds to a file.

A user of the Windows® Explorer®-type GUI who desires to know the size of the child folder can obtain size information for the child folder node as follows: select and right-click on the icon for the child folder node in the table, which causes a menu dialog to open; and select the properties item on the menu. In response, the operating system will determine the total size of the files and/or folders included within the child folder node, and then the Windows® Explorer®-type GUI will open a separate dialog that shows, among other things, the size of the child folder node.

A known manager application used with a storage domain includes a GUI that illustrates the various components (e.g., a host being one type) of the storage-domain using a two-pane tree & table combination GUI that is similar in several respects to the Windows® Explorer®-type GUI. The known storage-manager GUI organizes and illustrates each type of component of the storage-domain as a top-category folder, e.g., there is a top-category folder corresponding to all hosts. Top-category folders cannot be sub-divided into subfolders. Each instance of a storage-domain component is illustrated as a node that reports directly to the top level folder for that type of component.

### SUMMARY OF THE INVENTION

An embodiment of the invention is directed to a method of generating a graphical portion of a graphical user interface (GUI), the graphical portion concerning various components of a storage domain. Such a method may comprise: illustrating a tree hierarchy; including, in the tree hierarchy, a node belonging to a first node-category, the first-category node representing the total instances of a particular type among the storage-domain components, and including, in the tree hierarchy, one or more subset nodes belonging to a second node-category reporting to the first-category node, each second-category subset node representing a subset of the total instances of the particular type of storage-domain component.

Other embodiments of the invention include related apparatus and machine-readable media having instructions, each of which may include features similar to elements of the method.

Additional features and advantages of the invention will be more fully apparent from the following detailed description of example embodiments and the accompanying drawings.

### BRIEF DESCRIPTION OF THE DRAWINGS

The drawings are: intended to depict example embodiments of the invention and should not be interpreted to limit the scope thereof.

FIG. 1 is an architecture diagram of a storage area network according to an embodiment of the invention.

FIG. 2 depicts a graphical portion of a graphical user interface (GUI) according to an embodiment of the invention in the context of an example circumstance in which use of the GUI can arise.

FIG. 3 depicts a variation on the graphical portion of FIG. 2.

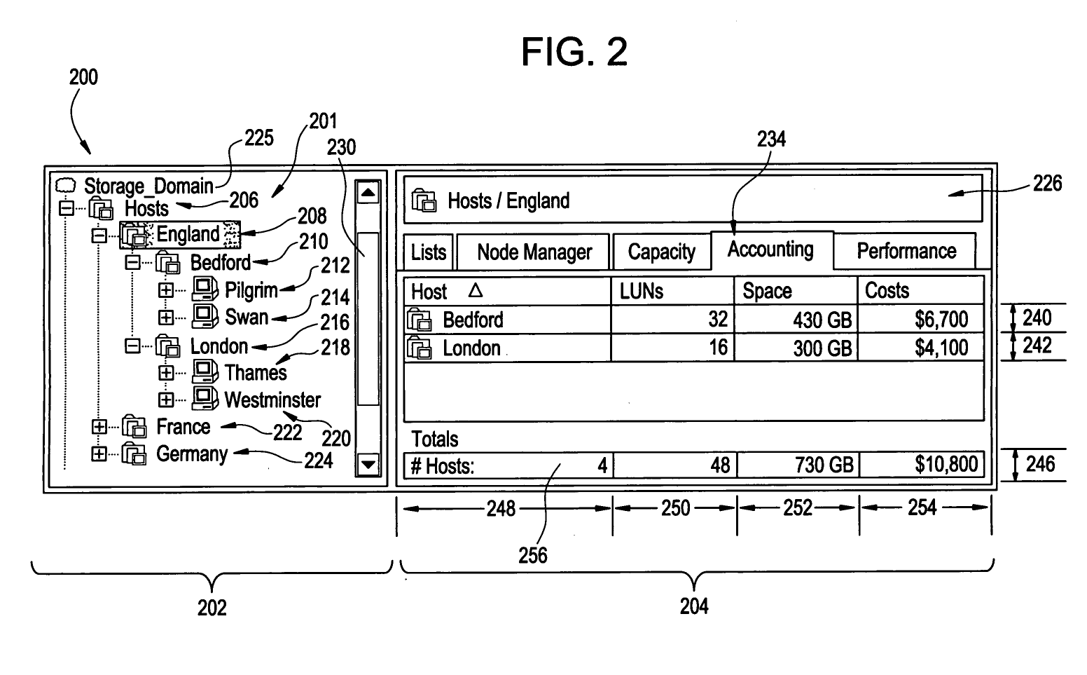

And FIG. 4 depicts another variation of the graphical portion of FIG. 2.

### DETAILED DESCRIPTION OF EXAMPLE EMBODIMENTS

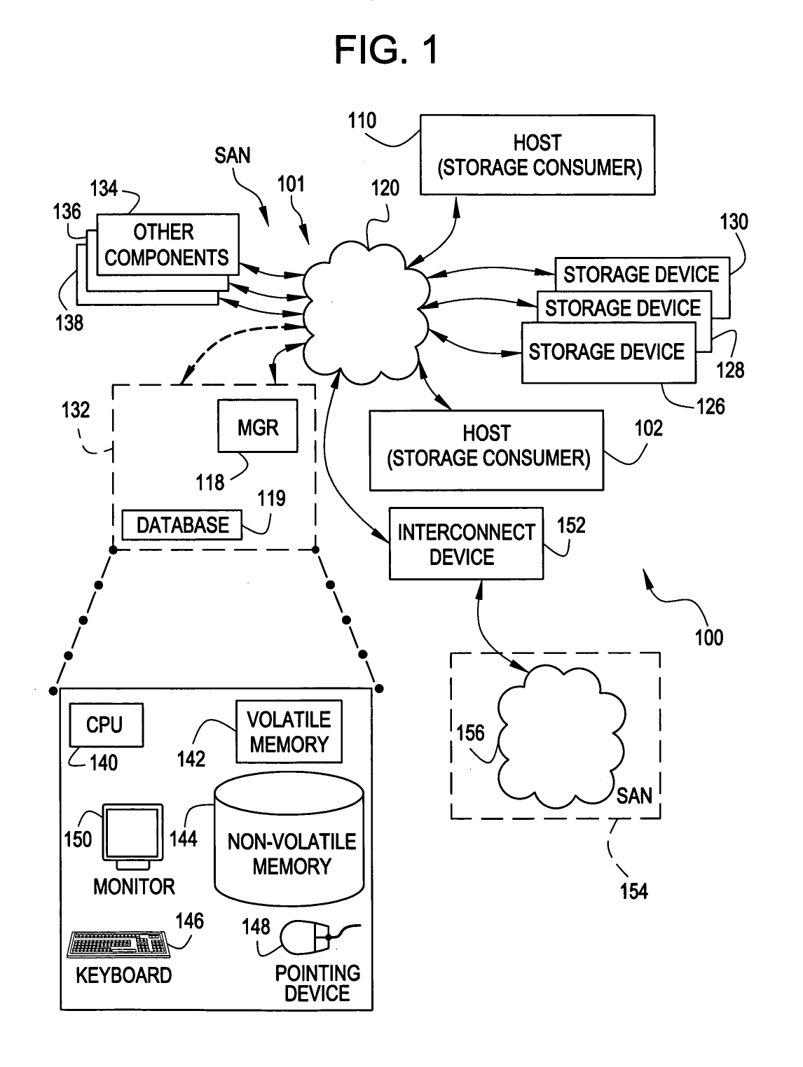

FIG. 1 is an architecture diagram of a distributed system 100, e.g., a storage domain. In the context of a storage-domain, e.g., 100, use can be made of a graphical user interface (GUI) according to an embodiment of the invention.

Components of the storage domain 100 can include: a storage area network (SAN) 101; one or more additional (and optional) SANs 154; interconnect devices; storage devices; hosts; business applications; etc. A tool used with a storage domain 100 is a storage area manager (SAM) 118.

A host, e.g., 102 and 110, is a consumer of storage capacity made available to it through the storage domain 100. Storage devices 126-130, e.g., network-attached storage (NAS) devices, are providers of storage capacity to the storage domain 100. The business applications, etc., are depicted as other components 134-138.

The SANs 101 and 154 each include a networking protocol and/or architecture (NPA) 120 and 156, respectively. An example 152 of an interconnect device has been depicted as connecting the SAN 154 to the SAN 101. Typically, an interconnect device, e.g., 152, is provided between two SANs, e.g., 101 and 154, because of one or more NPA-type differences and/or the magnitude of the physical distance in-between.

Various components of the storage-domain 100 components can include: a host, e.g., a storage provider, 102; one or more other hosts, e.g., storage providers, 110; storage devices, e.g., 126-130; and other components 134-138. Examples of other components 134-138 include: interconnect devices; bridges; managed applications; etc. Particular collections of storage-domain components vary according to circumstances in which the storage-domain is assembled and evolves.

In general operation of a storage domain that includes at least one SAN, the storage consumers are allotted respective amounts of storage capacity (made available by the storage devices) on the storage-domain 100. The provisioning, allotment and management of (including access to) the storage capacity is performed via the SAM 118.

Through the NPA 120, the interconnect device 152 and the NPA 156, the SAM 118 can communicate with the various components of the storage-domain 100, respectively, regardless of the particular SAN 101 or 154 to which the various components are most closely physically connected. Also, where permitted by the SAM 118, the hosts 102 and 110 can conduct writes/reads directly (in the sense of not needing the involvement of the SAM 118) to/from the storage devices 126-130, etc., via the NPA 120, the interconnect device 152 and the NPA 156, respectively.

As will be described below, the SAM 118 makes use of a GUI according to an embodiment of the invention, thus making the SAM 118 another embodiment of the invention. A graphical portion of such a GUI can, e.g., enhance a user's ability to manage the various storage-domain components. An example of a SAM that can be adapted according to the description provided below (and so represent an embodiment of the invention) is the Hewlett-Packard Company brand OpenView® Storage Area Manager (OVSAM®) model of storage manager.

Typically, the SAM 118 is an application loaded on a host 132 (shown with phantom lines) that is connected to the NPA 120. In general, a host is a computer that can provide/receive data and/or services via an NPA, e.g., 120. An exploded view (shown via different phantom lines) of typical components found in the host 132 includes: a central processing unit (CPU) 140; volatile memory 142; non-volatile memory 144; a keyboard 146; a pointing device, e.g., a mouse, 148; and a monitor 150.

FIG. 2 depicts a graphical portion 200 of a graphical user interface (GUI) according to an embodiment of the invention (hereafter, the “present GUI”) in the context of an example circumstance in which use of the present GUI can arise, which in FIG. 2 is the context of a storage domain, e.g., 100. The graphical portion 200 can be depicted, e.g., on a display screen (e.g., 150). The SAM 118 can produce the present GUI, e.g., via the CPU 140, etc. generating the graphical portion 200.

For ease of discussion, the graphical portion 200 is couched in the example circumstances of a storage-domain 100 having particular albeit fictitious storage-domain components that exhibit particular albeit (again) fictitious attributes. Hence, the graphical portion 200 has been illustrated with particular examples of labels for nodes, particular examples of parameters, and example values for the parameters. It should be understood that such labels, parameters and values will differ depending upon the circumstances in which use of the present GUI arises.

It should also be noted that the present GUI is not limited in application to the context of a storage-domain. Rather, the present GUI can be applied, e.g., to any hierarchy having a significant number of child nodes (each representing an instance of the total instances corresponding to the parent node) that all report to the same top-category parent node and/or to any hierarchy for which tabular summarization of child node information (see the discussion below) is relevant.

The graphical portion 200 includes a first pane 202 illustrating a tree hierarchy 201 and a second pane 204 illustrating a table (hereafter, “table 204”). The following description addresses the tree hierarchy 201 and then (further below) the table 204. It should be noted that the second pane 204 can depict a constellation other than a table.

A database 119, e.g., an SQL database loaded on the host 132, maintains information about the storage-domain 100 and the various storage-domain components. The tree hierarchy 201 can be represented in the database 119, or alternatively in the SAM 118, as lists of data objects corresponding to the storage-domain 100 and the various storage-domain components. For example, each node in the tree hierarchy 201 can be represented as a list including data objects that represent all of its child nodes, respectively.

The tree hierarchy 201 includes: nodes 210 and 216 belonging to a first category of node; and nodes 212, 214, 218 and 220 belonging to a second category of node. The second-category nodes 212 and 214 report to the first-category node 210. The second-category nodes 218 and 220 report to the first-category node 218.

The tree hierarchy 201 further includes: nodes 208, 222 and 224 belonging to a third category of node; a node 206 belonging to a fourth category of node; and node 225 belonging to a fifth category of node. The first-category nodes 210 and 216 report to the third-category node 208. The third-category nodes 208, 222 and 224 report to the fourth-category node 206. The fourth-category node 206 reports to the fifth-category node 225.

The expanse of the tree hierarchy 201 can reach beyond what can fit within the boundaries of the pane 202 using a typical font size. Hence, the pane 202 typically will depict a truncation of the tree 201. To facilitate viewing all parts of the tree hierarchy 201, a scroll bar 230 can be provided in the pane 202. The scroll bar 230 is oriented vertically. Optionally, a horizontal scroll bar can be provided for similar reasons.

Again, for ease of discussion, the nodes have been given the following specific labels relevant to the context of the storage-domain example. The node types will be discussed below.

| Node | Node | |
|---|---|---|
| Type | No. | Label |
| subset | 206 | Hosts |
| subset | 208 | England |
| subset | 210 | Bedford |
| instance | 212 | Pilgrim |
| instance | 214 | Swan |
| subset | 216 | London |
| instance | 218 | Thames |
| instance | 220 | Westminster |
| subset | 222 | France |
| subset | 224 | Germany |
| subset | 225 | Storage_Domain |

The Thames node 218 and the Westminster node 220 can correspond, e.g., to the hosts 102 and 110, respectively. Though FIG. 1 shows the SAN 101 (and thus also the storage-domain 100) as having only the two hosts 102 and 110, the SAN 101 (and the storage-domain 100) can include many more hosts; moreover, the example of FIG. 2 assumes many more than two hosts. In actuality, it is common for a storage-domain to have an order or two orders of magnitude more hosts than is depicted in FIG. 1.

The present GUI permits nodes at any level of the tree hierarchy to be organized into subsets. The examples of labels given to the nodes 206-225 reflect a geographical organization of the hosts on the storage-domain 100. Organizing the hosts other than by geographical location is contemplated, one example of which is in terms of data centers. In the data-center example of organization, subset nodes corresponding to data centers would be created, perhaps at the level in the tree hierarchy at which the subset nodes 208, 222 and 224 appear in FIG. 2.

In contrast to the node organizational flexibility exhibited by the present GUI, a corresponding tree hierarchy according to the known storage manager GUI of the Background Art would depict every instance of a host as a node one level below and directly reporting to the top-level node for hosts, which (in terms of FIG. 2) is the fourth-category node 206. An embodiment of the invention (at least in part) is the recognition of the following. Where there are more than a few instances of hosts, the tree hierarchy depicted by the known storage manager GUI of the Background Art can become unwieldy, making it difficult for a user to glean information from the tree-hierarchy. Further, where there are more than a few instances of hosts, it is common for the user of a SAM to be seeking information about a small subset of the total instances of hosts, hence it would be beneficial to be able to group together, e.g., on the tree hierarchy, the small subset of interest.

Returning in more detail to FIG. 2, the tree hierarchy 201 reflects a circumstance in which a user has used the present GUI to organize the total instances of hosts into three subsets, labeled England (208), France (222) and Germany (224). As such, the nodes 208, 222 and 224 can be described as subset nodes. The subset corresponding to the England node 208 itself has been organized into subsets, namely the subset nodes labeled Bedford (210) and London (216). The Hosts node 206 is itself a subset node that reports to the node 225 labeled storage-domain.

All types of the storage-domain components can report ultimately to the storage-domain node 225, making the storage-domain node 225 be the top-category node for storage-domain components. As such, the storage-domain node 225 corresponds to the set of storage-domain components relative to which all of the subset nodes are members. So the storage-domain node 225 can be described as a set node.

The node labeled Pilgrim 212 (an instance of a host) and the node labeled Swan 214 (another instance of a host) have been put into the subset corresponding to the node Bedford 204. Similarly, the subset corresponding to the node London 216 is a parent to the nodes Thames 218 (another instance of a host) and Westminster 220 (another instance of a host). Because each of the nodes 212, 214, 218 and 220 does not correspond to a grouping of instances of hosts but instead a particular instance of host, the nodes 212, 214, 218 and 220 can be described as instance nodes.

The graphical portion 200 and the present GUI represent an adaptation of the known tree & table combination GUI found in the Windows® Explorer® model of file browser that is part of the Windows® brand family of windows-based operating systems made available by the Microsoft® Corporation. Elements of the tree hierarchy 201 in many respects are analogous to folders and files, respectively, in the Windows® Explorer®-type GUI.

More particularly, the England node 208, the France node 222 and the Germany node 224 (as well as the nodes 206, 210 and 216) analogize to folders in the Windows® Explorer®-type GUI, and so are depicted with a folder icon [symbol] . The Pilgrim node 212, the Swan node 214, the Thames node 218 and the Westminster node 220 analogize to files in the Windows® Explorer®-type GUI; but they are depicted with a computer icon [symbol] . The storage-domain node 225 is depicted with a cloud icon [symbol] .

In FIG. 2, the user has selected the node 208, hence it is shown in reversed color mode. Also, the user has drilled down to open the England node 208, as indicated by the collapsible icon adjacent the England node. The user has not drilled down into either the France node 222 or the Germany node 224, as indicated by respective expandable icons [symbol] .

In the context of the storage-domain example, a user of the present GUI can, in a manner analogous to the Windows® Explorer®-type GUI, do the following: create, rename/relabel, move and delete subset nodes; and rename/relabel and move instance nodes. In contrast to the Windows® Explorer®-type GUI, copying of any type of node representing a storage-domain component is not permitted. And deletion of a subset node analogizes to a specialized move operation.

It is to be recalled that instance nodes represent real hardware for which analogy to copying of files is breaks down; hence, a copy function has not been provided. Also, deleting a subset node does not delete (from the storage-domain) those hosts corresponding/reporting to the now-deleted subset node, so here too the analogy breaks down. Rather, the present GUI responds to deletion of a subset node by moving the now-orphaned instance nodes to report directly to the Hosts subset node 206. Alternatively, the now-orphaned subset nodes can be moved so as to report directly to another subset node, e.g., the parent node of the now-deleted subset node.

In similar fashion, the addition of a storage-domain component such as a host 102, 110 to the storage-domain 100 can be automatically detected in the database 119 and automatically reflected in the tree hierarchy 201 by the present GUI. For example, in a fashion corresponding to how deletion is accommodated, the present GUI can automatically generate an instance node corresponding to the newly-added host and assign the instance node to report directly to, e.g., the Hosts subset node 206.

Regardless of the which node becomes the parent node of the now-orphaned nodes, the database 119 is updated once the now-orphaned nodes are adopted. The list representing the new parent node, as well as the lists representing new ancestor nodes (new grandparent, new great-grandparent, etc., to the extent that there are any) in the database 119 are updated to reflect the addition of the now-adopted nodes. The lists in the database 119 corresponding to now-former ancestor nodes (grandparent, great-grandparent, etc.) to which the now-adopted nodes no longer indirectly report (to the extent that there are any) are updated to reflect the removal of the now-adopted nodes.

A subset node can be created, e.g., by the following use of the present GUI: clicking (e.g., via the mouse 148) on the node (e.g., depicted as an icon on the graphical portion 200 appearing on the monitor 150) to which the new subset node will report, which can open a popup menu; selecting a menu item named New Subset Node, which then opens a New-Subset dialog; and supplying (e.g., via the keyboard 146 and the mouse 148) a label for the subset node. Existing instance nodes and subset nodes can be moved (made to report) to a target subset node by dragging/dropping the selected node to/onto the target subset node.

The table 204 will now be discussed in more detail. The table is adaptively arranged in response to a selection of one of the nodes in the tree hierarchy 201.

The table 204 is illustrated as having multiple tabs. On each tab, a table can be illustrated. For ease of discussion, this arrangement can be described as the table 204 being formed of multiple tabbed subtables. Providing the table 204 with multi-tabs is an additional technique for organizing information. It is to be noted that the multi-tab aspect is optional. In the example of FIG. 2, a tab 234, having the label “accounting”, has been selected. Other tabs in the multi-tab example of FIG. 2 are: list; node manager; capacity; and performance.

The subtable 234 includes: rows 240-242 and 246; and columns 248-254. The rows 240 and 242 present information about the Bedford subset node 210 and the London subset node 216, respectively, that report to the selected England subset node 208.

In general, a subset node typically has several child nodes to which it is a parent. A subset node can be empty, e.g., after it has been created and before it has been populated with a first child node, e.g., a subset node or an instance node. A subtable 234 (or the table 204 if multi-tabs are not employed) has a row associated with each child node (assuming at least one is present) for which the node selected in the tree hierarchy is a parent.

The columns 248-254 of the subtable 234 in FIG. 2 show parameters of the respective nodes. Column 248 shows the labels of the subset nodes reporting to the selected England subset node, namely the label Bedford in row 240 and London in row 242. Column 250 shows the number of logical units (LUNs) that the respective node's corresponding elements can access. Column 252 shows the amount of storage space made available on the storage-domain 100 to the respective node's elements. Column 254 shows a cost per unit of time charged to the respective node on the basis of parameters and specific values in columns 252 and/or 250. Other parameters are contemplated, both with respect to the specific storage-domain components known as hosts, as well as for the various other storage-domain components. Furthermore, still other parameters are contemplated where use of the present GUI arises in contexts, respectively, other than a storage-domain.

The row 246 presents information about the selected England subset node 208. Inspection of the subtable 234 reveals that cells in the row 246, with the exception of the cell 256, show sums of the values in the corresponding cells of the rows 240 and 242. Cell 256 shows the sum of the number of hosts corresponding to the Bedford subset node 210 and the London subset node 216.

In the example of FIG. 2, the child nodes reporting to the selected tree node (the England subset node 208) are themselves subset nodes, namely the Bedford subset node 210 and the London subset node 216. The values in the cells of the rows 240 and 242, relative to the columns 250-254, are themselves sums of the child nodes that report to the Bedford subset node 210 and the London subset node 216.

There can be an alternative circumstance in which one or more nodes that report to the selected node in the tree hierarchy 201 are instance nodes. In this alternative circumstance, the rows in the subtable 234 (or the table 204 if multi-tabs are not employed) corresponding to the instance nodes would show a value in each of the various parameter cells (e.g., relative to the columns 250-254) that represents an individual value associated with the individual host (or individual storage-domain component) to which the instance node corresponds.

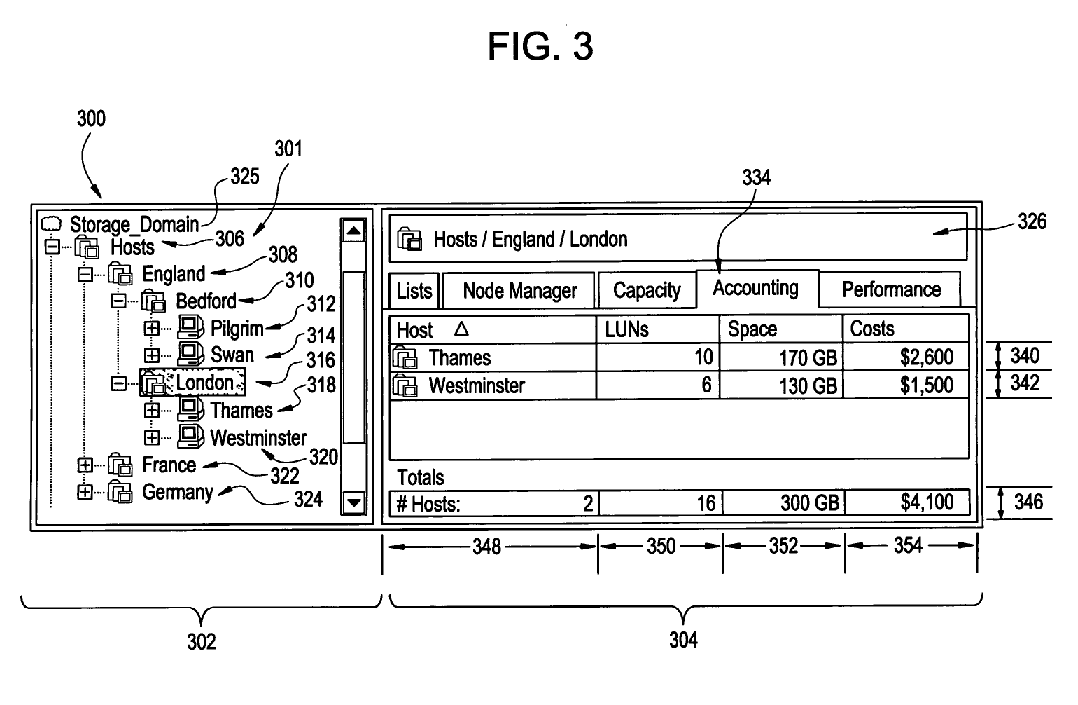

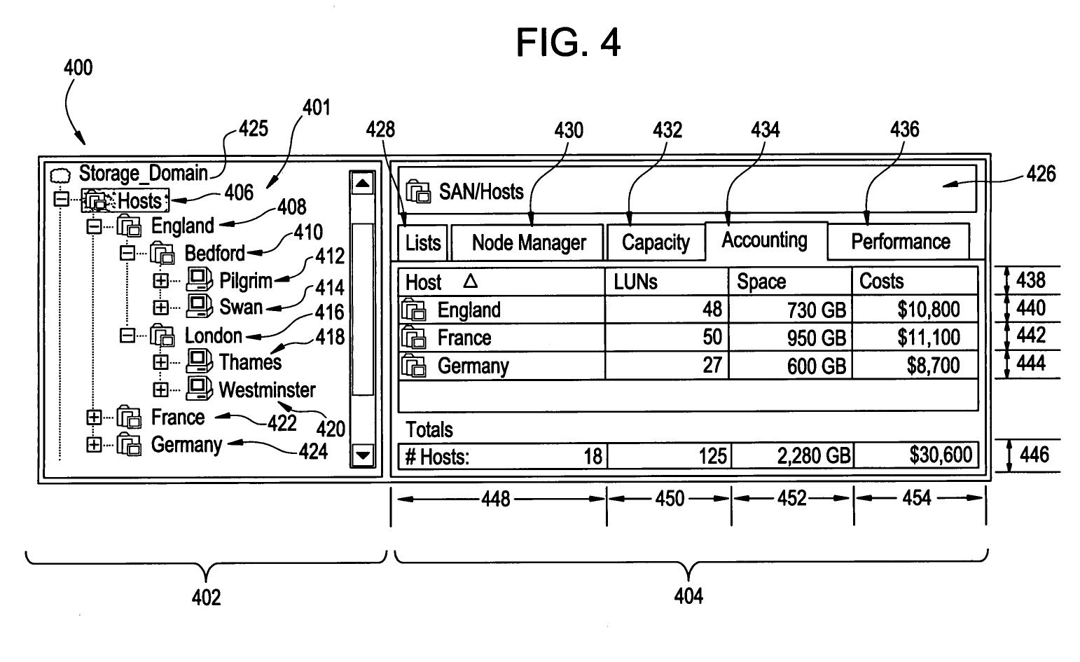

FIG. 3 depicts a variation 300 of the graphical portion 200 of FIG. 2 for the circumstance in which two nodes reporting to the selected tree node are instance nodes. Item numbers have been used in FIG. 3 in a manner corresponding to FIG. 2, e.g., the London subset node having item No. 216 in FIG. 2 correspondingly has item No. 316 in FIG. 3; the Thames and the Westminster instance nodes 218 and 220 of FIG. 2 are item Nos. 318 and 320, respectively, in FIG. 3, etc. Hence a generalized discussion of FIG. 3 is not provided, for brevity.

In the example of FIG. 3, the London subset node 316 in the tree hierarchy 301 has been selected by a user. The present GUI has adaptively arranged the subtable 334 in response to the London subset node 316 having been selected. The child nodes, for which the London subset node 316 is a parent, are each instance nodes, namely the Thames instance node 318 and the Westminster instance node 320. Accordingly, the values in the cells of the rows 340 and 342, relative to the columns 350-354, are individual values associated with the individual host (or individual storage-domain component) to which the instance node corresponds. Similarly, the row 346 is a summary row, which in FIG. 3 presents summary information about the selected London subset node 316.

Returning to FIG. 2, the table 204 also includes a title section 226, which can show the name of the node selected in the tree hierarchy 201. As an optional aspect, the title area can further show a partial (at the least) pathname to the node selected in the tree hierarchy 201. Such a pathname typically would include, at the least, an identifier of the node which is the parent to the node selected in the tree hierarchy 201. As another optional aspect, the title section 226 can include the icon indicating the type of node (e.g., the computer, folder or cloud icon) selected in the tree hierarchy 201.

In the example FIG. 3 (which, again, depicts a variation 300 of the graphical portion 200 of FIG. 2), the title section 326 shows the partial pathname “Hosts/England/London”. This indicates the following: the selected tree node is London 316; the parent of the London node 316 is the subset node England 308; and the Hosts node 306 is the parent of the England node 308 and the grandparent of the London node 316.

FIG. 4 depicts a variation 400 of the graphical portion 200 of FIG. 2 for the circumstance in which the user has selected the Hosts subset node 406 in the tree hierarchy 401. As was the case with FIG. 3, item numbers have been used in FIG. 4 in a manner corresponding to FIG. 2, e.g., the Hosts subset node having item No. 208 in FIG. 2 correspondingly has item No. 408 in FIG. 4; and the England, France and Germany subset nodes 208, 222 and 224 of FIG. 2 are item Nos. 408, 422 and 424, respectively, in FIG. 4, etc. Hence a generalized discussion of FIG. 4 is not provided, for brevity.

In FIG. 4, three child nodes report to the selected Hosts subset node 406 in the tree hierarchy 401. Accordingly, the sub-table 404 includes three rows 440-444 corresponding to the children, namely the England subset node 408, the France subset node 422 and the Germany subset node 424, respectively.

The child nodes 408, 422 and 424 are themselves subset nodes. The values in the cells of the rows 440, 442 and 444, relative to the columns 450-454, are themselves sums of the child nodes that report to the England subset node 408, the France subset node 422 and the Germany subset node 424. The summary row 446 presents information about the selected tree node. In other words, the information in the row 446 represents a summary of the respective information in the rows 440-444.

Optionally, if the expanse of the subtable 234 were to reach beyond what can fit within the boundaries of the pane 204 using a typical font size, vertical and/or horizontal scroll bars can be provided to facilitate viewing all parts of the subtable 234.

As is apparent from the foregoing, embodiments of the invention can take the form of methods, software and computers adapted to run such software and/or methods. The software can be offered to the user in the form of a computer-readable storage medium. The storage medium may be a built-in medium installed inside a computer main body or removable medium arranged so that it can be separated from the computer main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable non-volatile memory, such as memory cards; and media with a built-in ROM, such as ROM cassettes.

Again, some of the discussed embodiments of the invention arise in the context of a storage-domain, such a context should not be considered a limitation upon the invention.

The invention being thus described, it will be obvious that the same may be varied in many ways. Such variations are not to be regarded as a departure from the spirit and scope of the invention, and all such modifications are intended to be included within the scope of the invention.

1. A method of generating a graphical portion of a graphical user interface (GUI), the method comprising:
illustrating, in the same graphical portion, a tree hierarchy and a table of values;
including, in the tree hierarchy,
one or more nodes belonging to a first node-category and
one or more nodes belonging to a second node-category and corresponding to a group of elements;
adaptively arranging the table, in response to a selection of one of the first-category nodes via the GUI, to include
one or more rows that present information about the one or more second-category nodes, respectively, and that report to the selected one of the first-category nodes, and
one or more columns representing a parameter of one or more the second-category nodes, respectively; and
showing, in the rows, sums of individual values exhibited by elements of the group, respectively.

2. The method of claim 1, the method further comprising:
including, in the tree hierarchy, at least one node belonging to a third node-category;
wherein the one or more first-category nodes report to the at-least-one third-category node, respectively.

3. The method of claim 1, wherein:
the elements in the tree hierarchy represent a component in a storage domain;

4. The method of claim 3, wherein the parameter of the storage-domain component includes one of the following: a number of LUNs to which the element has access; an amount of storage space made available to the element; and a cost per unit time of an amount of storage made available to the element.

5. The method of claim 4, wherein:
one of the one-or-more columns represents the storage-space-amount parameter;
the at-least-one row associated via the at-least-one second-category node with the respective group of elements shows in a cell intersecting the storage-space-amount-parameter column a sum of the storage space represented by the elements of the group.

6. The method of claim 1, further comprising:
splitting the graphical portion into a first pane and a second pane;
the first pane containing the tree hierarchy; and
the second pane containing the table.

7. The method of claim 1, wherein:
the rows of the table are a first type of row; and
the method further comprises
including in the table a second type of row that presents information about the selected one of the first-category nodes.

8. The method of claim 7, wherein:
the second-type row has a cell corresponding to each of the one or more columns, respectively; and
the method further comprises
showing, for each of the one-or-more cells of the second-type row, a sum of the values in the corresponding cells of the first-type rows.

9. The method of claim 1, further comprising:
illustrating a title for the table, the title being an at least partial pathname to the selected one of the first-category nodes, the pathname including at least an identifier of a third level node to which the selected one of the first-category nodes reports.

10. The method of claim 1, further comprising:
including, in the tree hierarchy, a node belonging to a third node-category, the first-category nodes reporting to the third-category node;
wherein
the tree hierarchy concerns various-type components of a storage domain,
the third-category node represents the total instances of a particular type among the storage-domain components, and
each of the second-category nodes represents a subset of the total instances of the particular type of storage-domain component.

11. The method of claim 1, wherein the table is formed of multiple tabbed subtables.

12. A method of generating a graphical portion of a graphical user interface (GUI), the graphical portion concerning various components of a storage domain, the method comprising:
illustrating a tree hierarchy;
including, in the tree hierarchy, a node belonging to a first node-category, the first-category node representing the total instances of a particular type among the storage-domain components, and
including, in the tree hierarchy, one or more subset nodes belonging to a second node-category reporting to the first-category node, each second-category subset node representing a subset of the total instances of the particular type of storage-domain component.

13. The method of claim 12, wherein the type of storage-domain component is one of the following: a storage area network (SAN); an interconnect device; a storage device; a host; and a business application.

14. The method of claim 12, further comprising:
illustrating, in the tree hierarchy, one or more instance nodes belonging to the second node-category that reports to the first-category node, each second-category instance node representing a particular instance among the total instances of the particular type of storage-domain component.

15. The method of claim 12, further comprising:
illustrating, in the tree hierarchy, one or more instance nodes belonging to a third node-category reporting to the second-category subset nodes, respectively, each third-category instance node representing a particular instance among the subset of instances of the corresponding second-category subset node.

16. The method of claim 12, further comprising:
illustrating, in the tree hierarchy, a node a third node-category corresponding to the storage-domain as a whole, each first-category node reporting to the third-category node.

17. A machine-readable medium including instructions execution of which by a host produces a graphical portion of a graphical user interface (GUI), the machine-readable instructions comprising:
a code segment for illustrating, in the same graphical portion, a tree hierarchy and a table of values;
a code segment for including, in the tree hierarchy,
one or more nodes belonging to a first node-category and
one or more nodes belonging to a second node-category and corresponding to a group of elements;
a code segment for adaptively arranging the table, in response to a selection of one of the first-category nodes via the GUI, to include
one or more rows that present information about the one or more second-category nodes, respectively, and that report to the selected one of the first-category nodes, and
one or more columns representing a parameter of one or more the second-category nodes, respectively; and
a code segment for showing, in the rows, sums of individual values exhibited by elements of the group, respectively.

18. The machine-readable instructions of claim 17, the machine-readable instructions further comprising:
a code segment for including, in the tree hierarchy, at least one node belonging to a third node-category;
wherein the one or more first-category nodes report to the at-least-one third-category node, respectively.

19. The machine-readable instructions of claim 17, wherein:
the elements in the tree hierarchy represent a component in a storage domain;

20. The machine-readable instructions of claim 19, wherein the parameter of the storage-domain component includes one of the following: a number of LUNs to which the element has access; an amount of storage space made available to the element; and a cost per unit time of an amount of storage made available to the element.

21. The machine-readable instructions of claim 20, wherein:
one of the one-or-more columns represents the storage-space-amount parameter;
the at-least-one row associated via the at-least-one second-category node with the respective group of elements shows in a cell intersecting the storage-space-amount-parameter column a sum of the storage space represented by the elements of the group.

22. The machine-readable instructions of claim 17, further comprising:
a code segment for splitting the graphical portion into a first pane and a second pane;
the first pane containing the tree hierarchy; and
the second pane containing the table.

23. The machine-readable instructions of claim 17, wherein:
the rows of the table are a first type of row; and
the machine-readable instructions further comprise
a code segment for including in the table a second type of row that presents information about the selected one of the first-category nodes.

24. The machine-readable instructions of claim 23, wherein:
the second-type row has a cell corresponding to each of the one or more columns, respectively; and
the machine-readable instructions further comprise
a code segment for showing, for each of the one-or-more cells of the second-type row, a sum of the values in the corresponding cells of the first-type rows.

25. The machine-readable instructions of claim 17, further comprising:
a code segment for illustrating a title for the table, the title being an at least partial pathname to the selected one of the first-category nodes, the pathname including at least an identifier of a third level node to which the selected one of the first-category nodes reports.

26. The machine-readable instructions of claim 17, further comprising:
a code segment for including, in the tree hierarchy, a node belonging to a third node-category, the first-category nodes reporting to the third-category node;
wherein
the tree hierarchy concerns various-type components of a storage domain,
the third-category node represents the total instances of a particular type among the storage-domain components, and
each of the second-category nodes represents a subset of the total instances of the particular type of storage-domain component.

27. The machine-readable instructions of claim 17, wherein the table is formed of multiple tabbed subtables.

28. A machine-readable medium including instructions execution of which by a host produces a graphical portion of a graphical user interface (GUI), the graphical portion concerning various components of a storage domain, the machine-readable instructions comprising:
a code segment for illustrating a tree hierarchy;
a code segment for including, in the tree hierarchy, a node belonging to a first node-category, the first-category node representing the total instances of a particular type among the storage-domain components, and
a code segment for including, in the tree hierarchy, one or more subset nodes belonging to a second node-category reporting to the first-category node, each second-category subset node representing a subset of the total instances of the particular type of storage-domain component.

29. The machine-readable instructions of claim 28, wherein the type of storage-domain component is one of the following: a storage area network (SAN); an interconnect device; a storage device; a host; and a business application.

30. The machine-readable instructions of claim 28, further comprising:
a code segment for illustrating, in the tree hierarchy, one or more instance nodes belonging to the second node-category that reports to the first-category node, each second-category instance node representing a particular instance among the total instances of the particular type of storage-domain component.

31. The machine-readable instructions of claim 28, further comprising:
a code segment for illustrating, in the tree hierarchy, one or more instance nodes belonging to a third node-category reporting to the second-category subset nodes, respectively, each third-category instance node representing a particular instance among the subset of instances of the corresponding second-category subset node.

32. The machine-readable instructions of claim 28, further comprising:
a code segment for illustrating, in the tree hierarchy, a node a third node-category corresponding to the storage-domain as a whole, each first-category node reporting to the third-category node.

33. An apparatus for managing components of a system, the apparatus comprising:
a host operatively connected to the components of system; and
manager means for running on the host and for managing the components of the system in part by producing a graphical user interface (GUI); and
generation means for generating a graphical portion of the GUI, the generation means being operable to
portray, in the same graphical portion, a tree hierarchy and a table of values;
portray, in the tree hierarchy,
one or more nodes belonging to a first node-category and
one or more nodes belonging to a second node-category and corresponding to a group of elements;
adaptively dispose the table, in response to a selection of one of the first-category nodes via the GUI, to include
one or more rows that present information about the one or more second-category nodes, respectively, and that report to the selected one of the first-category nodes, and
one or more columns representing a parameter of one or more the second-category nodes, respectively; and
portray, in the rows, sums of individual values exhibited by elements of the group, respectively.

34. The apparatus of claim 33, wherein:
the system is a storage domain and the elements in the tree hierarchy represent a component in a storage domain;

35. The apparatus of claim 34, wherein a parameter of the storage-domain component includes one of the following: a number of LUNs to which the element has access; an amount of storage space made available to the element; and a cost per unit time of an amount of storage made available to the element.

36. The apparatus of claim 35, wherein:
one of the one-or-more columns represents the storage-space-amount parameter; and
the at-least-one row associated via the at-least-one second-category node with the respective group of elements shows in a cell intersecting the storage-space-amount-parameter column a sum of the storage space represented by the elements of the group.

37. The apparatus of claim 33, wherein:
the rows of the table are a first type of row; and
the generation means is further operable to dispose, in the table, a second type of row that presents information about the selected one of the first-category nodes.

38. The apparatus of claim 37, wherein:
the second-type row has a cell corresponding to each of the one or more columns, respectively; and
the generation means is further operable to dispose, for each of the one-or-more cells of the second-type row, a sum of the values in the corresponding cells of the first-type rows.

39. An apparatus for managing components of a storage domain, the apparatus comprising:
a host operatively connected to the components of the storage domain; and
storage area manager (SAM) means for running on the host and for managing the components of the storage domain in part by producing a graphical user interface (GUI); and
generation means for generating a graphical portion of the GUI, the graphical portion concerning various components of a storage domain, the generation means being operable to
portray a tree hierarchy;
portray, in the tree hierarchy, a node belonging to a first node-category, the first-category node representing the total instances of a particular type among the storage-domain components, and
portray, in the tree hierarchy, one or more subset nodes belonging to a second node-category reporting to the first-category node, each second-category subset node representing a subset of the total instances of the particular type of storage-domain component.

40. The apparatus of claim 39, wherein the type of storage-domain component is one of the following: a storage area network (SAN); an interconnect device; a storage device; a host; and a business application.

41. The apparatus of claim 39, wherein the generation means is further operable to dispose, in the tree hierarchy, one or more instance nodes belonging to the second node-category that reports to the first-category node, each second-category instance node representing a particular instance among the total instances of the particular type of storage-domain component.

42. The apparatus of claim 39, wherein the generation means is further operable to dispose one or more instance nodes belonging to a third node-category reporting to the second-category subset nodes, respectively, each third-category instance node representing a particular instance among the subset of instances of the corresponding second-category subset node.

43. The apparatus of claim 39, wherein the generation means is further operable to dispose a node a third node-category corresponding to the storage-domain as a whole, each first-category node reporting to the third-category node.

44. A method of generating a graphical portion of a graphical user interface (GUI), the method comprising:
illustrating, in the same graphical portion, a tree hierarchy and a constellation of values;
including, in the tree hierarchy,
one or more nodes belonging to a first node-category and
one or more nodes belonging to a second node-category and corresponding to a group of elements;
adaptively arranging the constellation, in response to a selection of one of the first-category nodes via the GUI, to include
regions that present information about the one or more second-category nodes, respectively, and that report to the selected one of the first-category nodes, and
the regions being organized in terms of one or more parameters of one-or-more of the second-category nodes, respectively; and
showing, in the regions, sums of individual values exhibited by elements of the group, respectively.

45. The method of claim 44, wherein the regions define the constellation as a table in which:
one or more rows present information about the one or more second-category nodes, respectively, that report to the selected one of the first-category nodes; and
the one or more parameters are represented via one or more columns, respectively; and
the sums of individual values for the one or more parameters exhibited by elements of the group, respectively, are shown in the rows.
